(19) United States
(12) Patent Application Publication
(10) Pub. No.: US 2026/0248251 A1
(43) Pub. Date: Aug. 27, 2026

(54) CASE FOR PORTABLE ELECTRONIC DEVICE

(71) Applicant: Gamber-Johnson LLC, Stevens Point, WI (US)

(72) Inventors: Walter P. Rothan, Cincinnati, OH (US); John R. Matthews, JR., Hamilton, OH (US); Tri Quoc Le, Tigard, OR (US)

(21) Appl. No.: 19/547,312

(22) Filed: Feb. 23, 2026

Related U.S. Application Data
(60) Provisional application No. 63/764,319, filed on Feb. 27, 2025.

(51) Int. Cl. A45C 11/00; G06F 1/16

(52) U.S. Cl. CPC A45C 11/003; G06F 1/1629

(57) ABSTRACT

A housing of a case for an electronic device includes a first portion and a second portion removably coupled to the first portion to collectively define a cavity configured to receive a portion of the electronic device. The first portion has a protrusion extending in a direction, and a flange including one of a bore or a through hole defined therein. The second portion has a protrusion extending in a direction opposite the direction of extension of the protrusion of the first portion, and a flange including another of the bore or the through hole defined therein. The housing further includes an interlocking mechanism coupling the first portion to the second portion, and a locking mechanism removably locking the first portion to the second portion. The interlocking mechanism has the protrusion of the first portion and the protrusion of the second portion.

### CROSS-REFERENCE TO RELATED APPLICATIONS

This application claims priority to U.S. Provisional Patent Application No. 63/764,319, filed Feb. 27, 2025, the entire contents of which are hereby incorporated herein by reference.

### FIELD OF THE INVENTION

The present invention relates to a case, and more particularly to a portable electronic device case.

### BACKGROUND OF THE INVENTION

Portable electronic devices, such as laptop computers, can be placed within protective cases to protect the portable electronic device from potential damage. Conventional cases provide varying levels of protection. However, many cases are designed to be easily removable by users, which can inadvertently reduce the level of security they provide. Therefore, there is a need for an improved laptop cover that cannot be easily or unintentionally removed.

### SUMMARY OF THE INVENTION

In some aspects, a top housing of a case is for a display screen of an electronic device. The top housing includes a first top portion and a second top portion removably coupled to the first top portion to collectively define a cavity configured to receive the display screen. The first top portion has a protrusion extending in a direction, and a flange including one of a bore or a through hole defined therein. The second top portion has a protrusion extending in a direction opposite the direction of extension of the protrusion of the first top portion, and a flange including another of the bore or the through hole defined therein. The top housing further includes an interlocking mechanism coupling the first top portion to the second top portion, and a locking mechanism removably locking the first top portion to the second top portion. The interlocking mechanism has the protrusion of the first top portion and the protrusion of the second top portion. The locking mechanism has a fastener extending through the through hole and into the bore.

In some aspects, the techniques described herein relate to a top housing, wherein the locking mechanism has an insert that is positioned within the bore and that receives the fastener.

In some aspects, the techniques described herein relate to a top housing, wherein one of the first top portion and the second top portion includes a bore configured to receive the insert, and wherein the other of the first top portion and the second top portion includes an aperture configured to receive the fastener.

In some aspects, the techniques described herein relate to a top housing, the second top portion includes a key having the protrusion of the second top portion, and the first top portion includes a recess receiving the key, and wherein the interlocking mechanism includes the key and the recess.

In some aspects, the techniques described herein relate to a top housing, wherein the protrusion extends in a direction perpendicular to a remainder of the key.

In some aspects, the techniques described herein relate to a top housing, wherein the interlocking mechanism includes an aperture that is positioned in the recess of the first top portion and that receives the protrusion of the second top portion.

In some aspects, the techniques described herein relate to a top housing, wherein the protrusion of the first top portion projects into the recess of the first top portion and engages the protrusion of the second top portion therein.

In some aspects, the techniques described herein relate to a top housing, wherein the locking mechanism is configured to lock the first top portion and the second top portion to the electronic device.

In some aspects, the techniques described herein relate to a top housing, wherein when the first top portion is coupled to the second top portion, the first top portion and the second top portion define a back wall configured to engage a first surface of the display screen of the electronic device, and a plurality of sidewalls configured to extend around a periphery of the display screen of the electronic device.

In some aspects, the techniques described herein relate to a top housing, wherein one of the plurality of sidewalls includes a lip configured to engage a second surface of the display screen of the electronic device, the second surface being opposite the first surface.

In some aspects, the techniques described herein relate to a top housing, further including a rim configured to be coupled to the plurality of sidewalls.

In some aspects, the techniques described herein relate to a top housing, wherein the protrusion is a first protrusion and the corresponding mating feature is a first corresponding mating feature, wherein the one of the first top portion and the second top portion includes a second protrusion configured to engage a second corresponding mating feature of the other of the first top portion and the second top portion.

In some aspects, the techniques described herein relate to a top housing, wherein one of the first top portion and the second top portion has a first projection supporting a first protrusion and has a second projection supporting a second protrusion, wherein the first projection and the second projection are received in the recess of the other of the first top portion and the second top portion, and wherein the first corresponding mating feature and the second corresponding mating feature are opposed protruding catches.

In some aspects, the techniques described herein relate to a top housing, wherein the projection is cantilevered with the protrusion positioned at a distal end of the projection.

In some aspects, the techniques described herein relate to a top housing, wherein the projection is resilient.

In some aspects, the techniques described herein relate to a top housing, wherein the rim includes rounded corner portions configured to engage a front or upper surface of the portable electronic device.

In some aspects, the techniques described herein relate to a top housing, wherein one of the first top portion and the second top portion includes a pair of flanges, each having a bore, and the other of the first top portion and the second top portion includes a pair of flanges, each having a through hole, wherein the first top portion and the second top portion are configured to be coupled such that the bores and through holes are aligned.

In some aspects, the techniques described herein relate to a case comprising the top housing and a bottom housing configured to be coupled to a keyboard.

In some aspects, the techniques described herein relate to a case, wherein the bottom housing includes an interlocking mechanism and a locking mechanism.

In some aspects, the techniques described herein relate to a case, wherein the bottom housing is formed as one piece and does not include a locking mechanism and interlocking mechanism.

In some aspects, a bottom housing of a case is for a display screen of an electronic device. The bottom housing includes a first bottom portion and a second bottom portion removably coupled to the first bottom portion to collectively define a cavity configured to receive the display screen. The first bottom portion has a protrusion extending in a direction, and a flange including one of a bore or a through hole defined therein. The second bottom portion has a protrusion extending in a direction opposite the direction of extension of the protrusion of the first bottom portion, and a flange including another of the bore or the through hole defined therein. The bottom housing further includes an interlocking mechanism coupling the first bottom portion to the second bottom portion, and a locking mechanism removably locking the first bottom portion to the second bottom portion. The interlocking mechanism has the protrusion of the first bottom portion and the protrusion of the second bottom portion. The locking mechanism has a fastener extending through the through hole and into the bore.

In some aspects, the techniques described herein relate to a bottom housing, wherein the locking mechanism has an insert that is positioned within the bore and that receives the fastener.

In some aspects, the techniques described herein relate to a bottom housing, wherein one of the first bottom portion and the second bottom portion includes a bore configured to receive the insert, and wherein the other of the first bottom portion and the second bottom portion includes an aperture configured to receive the fastener.

In some aspects, the techniques described herein relate to a bottom housing, wherein the second bottom portion includes a key having the protrusion of the second bottom portion, and the first bottom portion includes a recess receiving the key, and wherein the interlocking mechanism includes the key and the recess.

In some aspects, the techniques described herein relate to a bottom housing, wherein the protrusion extends in a direction perpendicular to a remainder of the key.

In some aspects, the techniques described herein relate to a bottom housing, wherein the interlocking mechanism includes an aperture that is positioned in the recess of the first bottom portion and that receives the protrusion of the second bottom portion.

In some aspects, the techniques described herein relate to a bottom housing wherein the protrusion of the first bottom portion projects into the recess of the first bottom portion and engages the protrusion of the second bottom portion therein.

In some aspects, the techniques described herein relate to a bottom housing, wherein the locking mechanism is configured to lock the first bottom portion and the second bottom portion to the electronic device.

In some aspects, the techniques described herein relate to a bottom housing, wherein when the first bottom portion is coupled to the second bottom portion, the first bottom portion and the second bottom portion define a back wall configured to engage a first surface of the keyboard of the electronic device, and a plurality of sidewalls configured to extend around a periphery of the keyboard of the electronic device.

In some aspects, the techniques described herein relate to a bottom housing, wherein one of the plurality of sidewalls includes a lip configured to engage a second surface of the keyboard of the electronic device, the second surface being opposite the first surface.

In some aspects, the techniques described herein relate to a bottom housing, wherein the plurality of sidewalls include a plurality of openings aligned with ports of the electronic device.

In some aspects, the techniques described herein relate to a bottom housing, further including a rim configured to be coupled to the plurality of sidewalls.

In some aspects, the techniques described herein relate to a bottom housing, wherein the protrusion is a first protrusion and the corresponding mating feature is a first corresponding mating feature, wherein the one of the first bottom portion and the second bottom portion includes a second protrusion configured to engage a second corresponding mating feature of the other of the first bottom portion and the second bottom portion.

In some aspects, the techniques described herein relate to a bottom housing, wherein the one of the first bottom portion and the second bottom portion has a first projection supporting a first protrusion and has a second projection supporting a second protrusion, wherein the first projection and the second projection are received in the recess of the other of the first bottom portion and the second bottom portion, and wherein the first corresponding mating feature and the second corresponding mating feature are opposed protruding catches.

In some aspects, the techniques described herein relate to a bottom housing, wherein the projection is cantilevered with the protrusion positioned at a distal end of the projection.

In some aspects, the techniques described herein relate to a bottom housing, wherein the projection is resilient.

In some aspects, the techniques described herein relate to a bottom housing, wherein the rim includes rounded corner portions configured to engage a front or upper surface of the portable electronic device.

In some aspects, the techniques described herein relate to a bottom housing, wherein one of the first bottom portion and the second bottom portion includes a pair of flanges each having a bore, and the other of the first bottom portion and the second bottom portion includes a pair of flanges each having a through hole, wherein the first bottom portion and the second bottom portion are configured to be coupled such that the bores and through holes are aligned.

In some aspects, the techniques described herein relate to a case comprising the bottom housing and a top housing configured to be coupled to a display screen.

In some aspects, the techniques described herein relate to a case, wherein the top housing includes an interlocking mechanism and a locking mechanism.

In some aspects, the techniques described herein relate to a case, wherein the top housing is formed as one piece and does not include a locking mechanism and interlocking mechanism.

In some aspects, a case for an electronic device includes a first housing configured to be coupled to a first surface of the electronic device, and a second housing configured to be coupled to a second surface of the electronic device. The first housing includes a first portion and a second portion configured to be coupled to the first portion. The second housing includes a third portion and a fourth portion configured to be coupled to the third portion. The case further includes a first interlocking mechanism, a first locking mechanism, a second interlocking mechanism, and a second locking mechanism. The first interlocking mechanism is configured to align and couple the first portion to the second portion. The first locking mechanism is configured to secure the aligned and coupled first portion and second portion together to inhibit separation of the first and second portions. The second interlocking mechanism is configured to align and couple the third portion to the fourth portion. The second locking mechanism is configured to secure the aligned and coupled third portion and fourth portion together to inhibit separation of the third and fourth portions. The first housing and the second housing are configured to be separately coupled to the electronic device.

In some aspects, the techniques described herein relate to a case, wherein the first locking mechanism includes a first fastener configured to extend through the first portion and the second portion, and wherein the second locking mechanism includes a second fastener configured to extend through the third portion and the fourth portion.

In some aspects, the techniques described herein relate to a case, wherein the first housing includes a first insert and the second housing includes a second insert, wherein the first fastener is configured to extend into the first insert and the second fastener is configured to extend into the second insert.

In some aspects, the techniques described herein relate to a case, wherein the first surface is a rear surface of a display screen of the electronic device, and wherein the second surface is an underside of a keyboard of the electronic device.

In some aspects, the techniques described herein relate to a case, wherein the first interlocking mechanism includes a first protrusion positioned on one of the first portion and the second portion and configured to engage a corresponding first mating feature on the other of the first portion and the second portion, and wherein the second interlocking mechanism includes a second protrusion positioned on one of the third portion and the fourth portion and configured to engage a corresponding second mating feature on the other of the third portion and the fourth portion.

In some aspects, the techniques described herein relate to a case, wherein each of the first mating feature and the second mating feature is an aperture.

In some aspects, the techniques described herein relate to a case, wherein each of the first mating feature and the second mating feature is a protruding catch.

In some aspects, the techniques described herein relate to a case, wherein the first housing and the second housing are configured to be independently attachable to and removable from the electronic device.

In some aspects, the techniques described herein relate to a case, wherein the first housing includes a first rim portion configured to engage a periphery of the electronic device.

In some aspects, the techniques described herein relate to a case, wherein the first rim portion is configured to engage a front surface of the display screen.

In some aspects, the techniques described herein relate to a case, wherein the second housing includes a second rim portion configured to engage a periphery of the electronic device.

In some aspects, the techniques described herein relate to a case, wherein the first rim portion is configured to engage an upper surface of the keyboard.

In some aspects, a case for an electronic device has a first housing portion and a second housing portion configured to be coupled to the first housing portion. One of the first housing portion and the second housing portion includes a first flange having a bore. The other of the first housing portion and the second housing portion includes a second flange having a through hole. The case includes an insert configured to be positioned within the bore, and a fastener configured to extend through the through hole and into the insert after the first housing portion and the second housing portion are coupled. When the fastener extends into the insert, the fastener prevents the electronic device from being removed from the case.

In some aspects, the techniques described herein relate to a case, wherein the fastener is a tamper-resistant hex screw.

In some aspects, the techniques described herein relate to a case, wherein the insert includes a threaded inner surface, and the fastener includes a threaded outer surface configured to engage the threaded inner surface of the insert.

In some aspects, the techniques described herein relate to a case, wherein the insert includes a textured outer surface configured to provide a frictional fit between the insert and the bore.

In some aspects, the techniques described herein relate to a case, further including an interlocking mechanism configured to align and couple the first housing portion to the second housing portion.

In some aspects, the techniques described herein relate to a case, wherein the interlocking mechanism includes a protrusion configured to engage a corresponding mating feature.

In some aspects, the techniques described herein relate to a case, wherein the fastener and the insert are configured to lock the first housing portion and the second housing portion to the electronic device.

### BRIEF DESCRIPTION OF THE DRAWINGS

FIG. 1 is a perspective view of a case for a portable electronic device according to an embodiment of the invention, illustrating the case secured to a laptop.

FIG. 2 is another perspective view of the case and the laptop of FIG. 1.

FIG. 3 is an exploded view of the case and the laptop of FIG. 1.

FIG. 4 is a perspective view of a top housing of the case of FIG. 1.

FIG. 5a is a front perspective view of the top housing of FIG. 4, illustrating a first top portion of the top housing removed from a second top portion of the top housing.

FIG. 5b is a rear perspective view of the top housing of FIG. 4, illustrating a first top portion of the top housing removed from a second top portion of the top housing.

FIG. 6 is an enlarged front perspective view of a locking mechanism of the case for securing the top housing of FIG. 4 to a portable electronic device.

FIG. 7 is a perspective view of a bottom housing of the case of FIG. 1.

FIG. 8a is a front perspective view of the bottom housing of FIG. 7, illustrating a first bottom portion of the bottom housing removed from a second bottom portion of the bottom housing.

FIG. 8b is a rear perspective view of the bottom housing of FIG. 7, illustrating a first bottom portion of the bottom housing removed from a second bottom portion of the bottom housing.

FIG. 9 is an enlarged rear perspective view of the locking mechanism of the case for securing the bottom housing of FIG. 7 to a portable electronic device.

FIG. 10 is a perspective view of a case for a portable electronic device according to another embodiment of the invention.

FIG. 11a is a front perspective view of a top housing of the case of FIG. 10, illustrating a first top portion of the top housing removed from a second top portion of the top housing.

FIG. 11b is a rear perspective view of the top housing of FIG. 11a, illustrating a first top portion of the top housing removed from a second top portion of the top housing.

FIG. 11c is an enlarged front perspective view of an interlocking mechanism of the top housing of FIG. 11a.

FIG. 11d is an enlarged rear perspective view of a locking mechanism of the case for securing the top housing of FIG. 11a to a portable electronic device.

FIG. 12a is a front perspective view of a bottom housing of the case of FIG. 10, illustrating a first bottom portion of the bottom housing removed from a second bottom portion of the bottom housing.

FIG. 12b is a rear perspective view of the bottom housing of FIG. 12a, illustrating a first bottom portion of the bottom housing removed from a second bottom portion of the bottom housing.

Before any embodiments of the invention are explained in detail, it is to be understood that the invention is not limited in its application to the details of construction and the arrangement of components set forth in the following description or illustrated in the following drawings. The invention is capable of supporting other embodiments and of being practiced or carried out in various ways. Also, it is to be understood that the phraseology and terminology used herein are for the purpose of description and should not be regarded as limiting. For example, as used herein and in the appended claims, the terms “upper,” “lower,” “top,” “bottom,” “front,” “back”, and other directional terms are not intended to require any particular orientation but are instead used for purposes of description only.

Other aspects of the disclosure will become apparent by consideration of the detailed description and accompanying drawings.

### DETAILED DESCRIPTION OF THE INVENTION

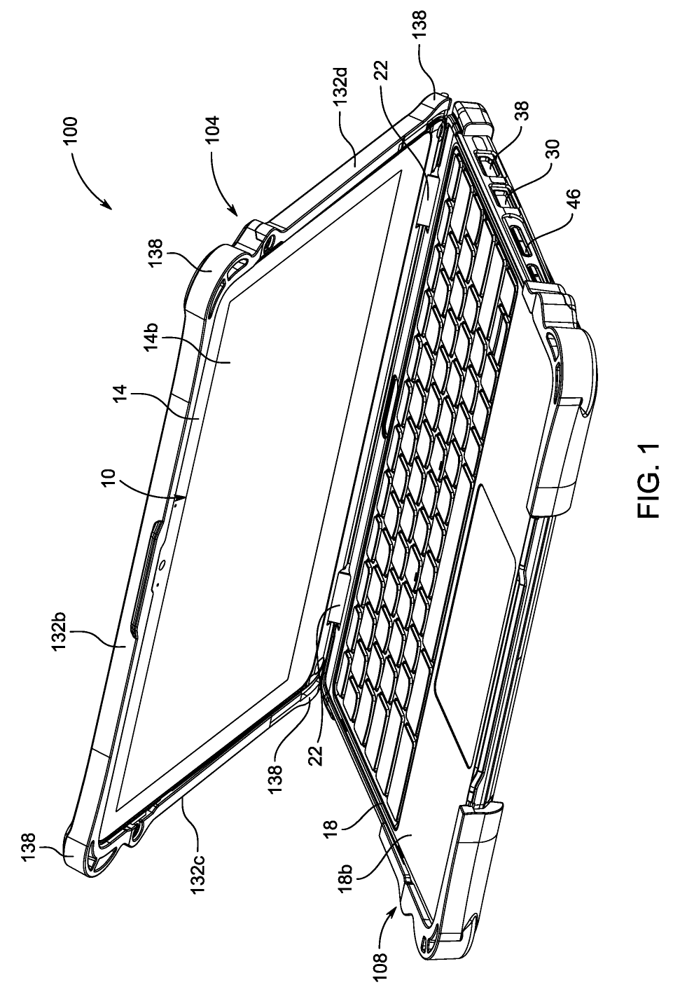

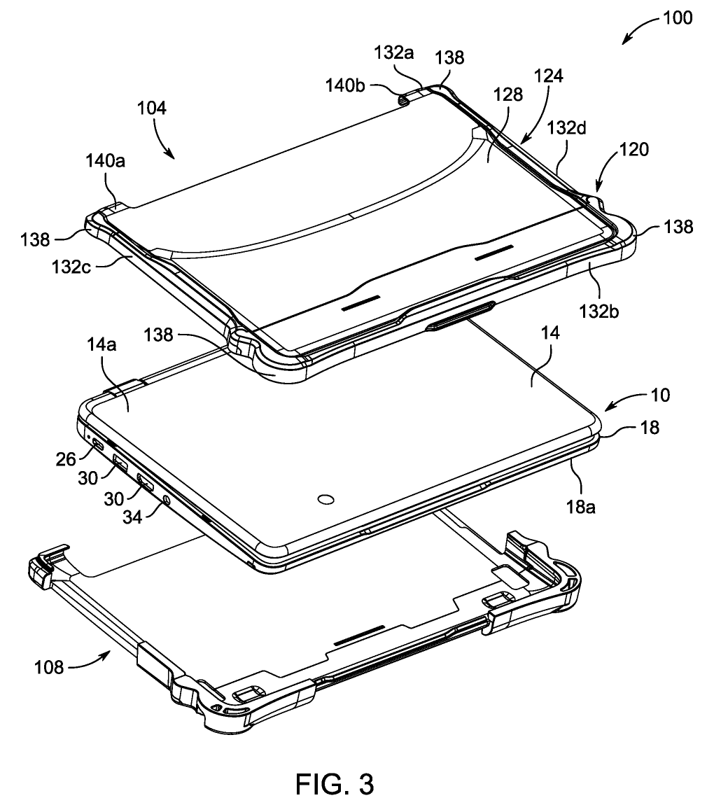

FIGS. 1-9 illustrate a case 100 for a portable electronic device 10. The device 10 may be, for example, a laptop computer, though in other embodiments, the case 100 may be compatible with other types of portable electronic devices. The illustrated case 100 includes a top housing 104 and a bottom housing 108. The housings 104, 108 are separate components securable to different portions of the laptop computer 10. Specifically, the top housing 104 is shaped and sized to receive and enclose a display screen 14 of the laptop computer 10, and the bottom housing 108 is shaped and sized to receive and enclose a keyboard portion 18 of the laptop computer 10. More specifically, as shown in FIG. 3, the top housing 104 receives and encloses a rear surface 14a of the display screen 14, and the bottom housing 108 receives and encloses an underside 18a of the keyboard portion 18. The housings 104, 108 may both be secured to the laptop 10 or used singly, and when attached, the laptop 10 remains fully operable.

With reference to FIGS. 3-5b and 7-8b, the top housing 104 and bottom housing 108 are substantially rectangular and include a main body 112 and a rim 116. As discussed in more detail below, the rim 116 surrounds the periphery of the main body 112 and is constructed, for example, of a resilient material, such as thermoplastic polyurethane (TPU), while the main body 112 is constructed, for example, of a rigid material, such as polycarbonate. In the illustrated embodiments, the main body 112 and the rim 116 are securely coupled together. For example, the rim 116 may be chemically bonded to the main body 112 via an injection co-molding process by which the molten TPU material of the rim 116 is injected around the perimeter of the polycarbonate main body 112. As it cools, the TPU will bond to the polycarbonate material. The rigid polycarbonate shell may include some small, not externally visible protruding features that assist in the bonding process. However, in alternative constructions, the main body 112 and the rim 116 may be permanently coupled by other methods or removably coupled to each other.

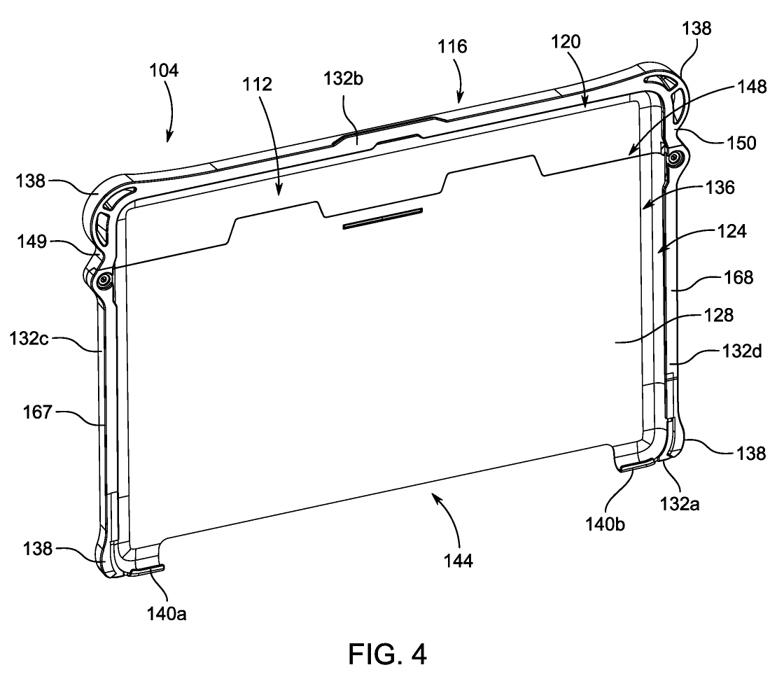

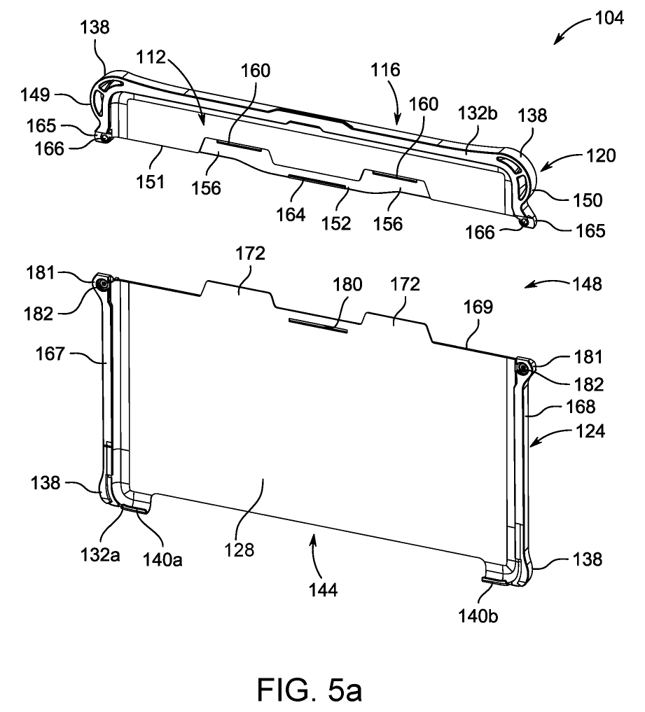

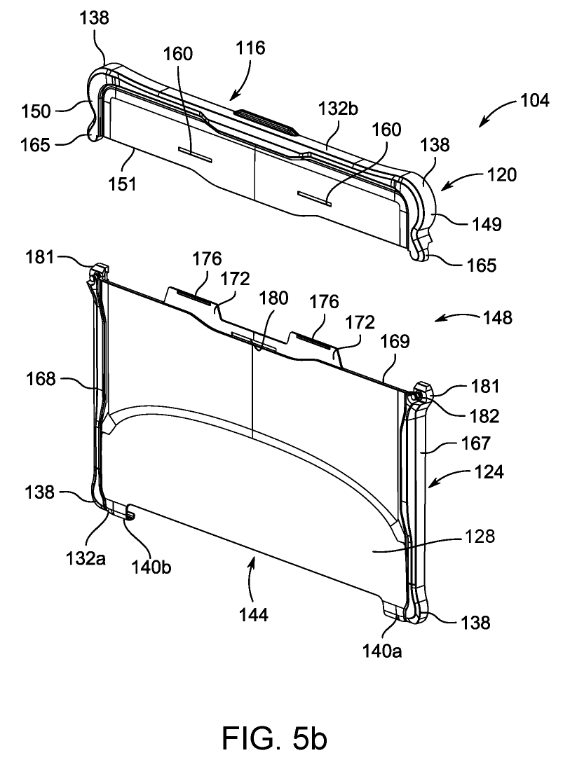

With reference to FIGS. 4-5b, the top housing 104 includes a first top portion 120 and a second top portion 124 configured to be removably coupled to the first top portion 120. When coupled together, the first and second top portions 120, 124 define a rigid back wall or floor 128 and four rigid sidewalls 132a-d, which may be formed from the same rigid material as that of the main body 112, and collectively define a cavity 136 to receive and hold the laptop display screen 14. The rigid sidewalls 132a-d may be co-molded with the back wall 128, such that they are permanently secured together. In other embodiments, the sidewalls 132a-d may be formed separately from the back wall 128 and subsequently coupled to the back wall 128. The rigid sidewalls 132a-d include a bottom sidewall 132a, a top sidewall 132b, a left sidewall 132c, and a right sidewall 132d. When the top housing 104 is coupled to the laptop 10, the sidewalls 132a-d extend around the periphery of the laptop display screen 14. As discussed above, the resilient rim 116 is coupled to portions of the top sidewall 132b, the left sidewall 132c, and the right sidewall 132d, and provides the top housing 104 with rounded corners 138. The rounded corners 138 are shaped and sized to engage a front surface 14b (FIG. 1) of the laptop display screen 14. Together, the sidewalls 132a-132d and the rim 116 capture the laptop display screen 14 to securely hold the display screen 14 within the top housing 104.

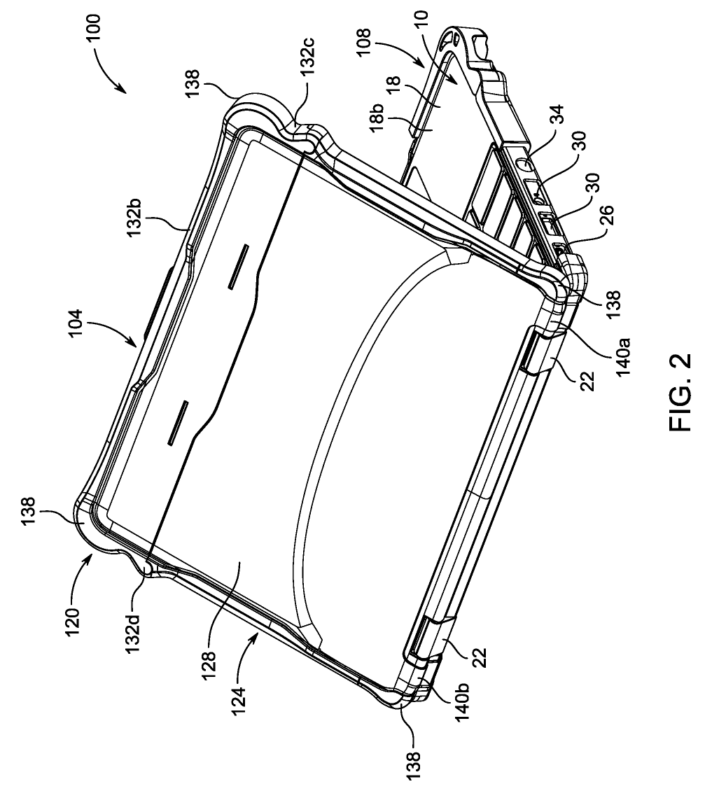

The bottom sidewall 132a includes a first rigid lip 140a formed from the same rigid material as the sidewalls and positioned adjacent the left sidewall 132c, a second rigid lip 140b that is formed from the rigid material of the sidewalls and positioned adjacent the right sidewall 132d, and an opening 144 extending between the first and second lips 140a, 140b. The lips 140a, 140b are shaped and sized to engage the front surface 14b (FIG. 1) of the laptop display screen 14, securing the top housing 104 to the laptop display screen 14 together with the sidewalls 132a-d. As described below and depicted in FIGS. 1-2, when the laptop display screen 14 is secured within the assembled top housing 104, it cannot be inadvertently or easily removed from the top housing 104 by users. The opening 144 accommodates hinges 22 (FIGS. 1-2) of the laptop 10.

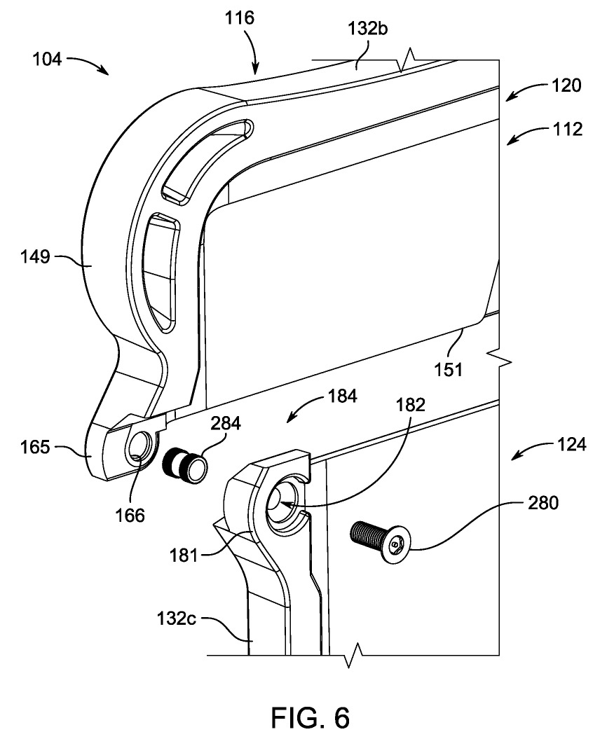

As illustrated in FIGS. 5a-5b, the first top portion 120 of the top housing 104 is coupled to the second top portion 124 via an interlocking mechanism 148. The first top portion 120 includes the top sidewall 132b, an upper portion 149 of the left sidewall 132c, and an upper portion 150 of the right sidewall 132d. A bottom edge 151 of the first top portion 120 includes a recess 152 that defines two generally rectangular sections 156, such that each section 156 includes a catch formed as an elongate, rectangular aperture 160. The aperture 160 is a mating feature. Positioned between the sections 156 is a mating feature formed as a protrusion 164 that extends outwardly from the recess 152 in a first direction (toward the front surface of the back wall 128, which faces the rear surface 14a of the laptop display screen 14 as viewed from the perspective of FIG. 5a) and is generally rectangular in shape. Distal ends of the upper portion 149 of the left sidewall 132c and the upper portion 150 of the right sidewall 132d are recessed and offset in a first recess direction, thereby forming two first flanges 165, each of which includes a bore 166 (FIG. 6).

With continued reference to FIGS. 5a-5b, the second top portion 124 of the top housing 104 includes the bottom sidewall 132a, a lower portion 167 of the left sidewall 132c, and a lower portion 168 of the right sidewall 132d. An upper edge 169 of the second top portion 124 includes a pair of mating features corresponding to the apertures 160 and formed as keys 172, each shaped and sized to fit securely within one of the recesses 152 of the first top portion 120. The keys 172 are generally rectangular, and each key 172 includes a protrusion 176 (FIG. 5b) that extends outwardly from the key 172 in a second direction (toward the back surface of the back wall 128 as viewed from the perspective of FIG. 5a) that is opposite the first direction. Another mating feature corresponding to the protrusion 164 and formed as an elongate, rectangular aperture 180 is positioned between the keys 172. Distal ends of the lower portions 167, 168 of the left sidewall 132c and right sidewall 132d are recessed and offset in a second recess direction opposite the first recess direction, thereby forming two second flanges 181, each corresponding to a first flange 165 and including a through hole 182 (FIG. 6).

When the first top portion 120 and the second top portion 124 of the top housing 104 are coupled together, each key 172 is seated within the recess 152. Specifically, the keys 172 fit into and are seated in the rectangular sections 156. The protrusions 176 of the second top portion 124 extend through the apertures 160 of the first top portion 120, while the protrusion 164 of the first top portion 120 extends through the aperture 180 of the second top portion 124. The first flanges 165 align with the second flanges 181, such that the bores 166 are aligned with the through holes 182. In some embodiments, the first top portion 120 may include either a bore configured to receive the insert or an aperture, and the second top portion 124 may include the other of the bore or the aperture. Because the protrusions 164 and 176 extend in opposite directions into their corresponding apertures 180 and 160, respectively, the engagement of the protrusions 164, 176 with their respective apertures 180, 160 serves to prevent the top portions 120 and 124 from being easily separated from each other. Thus, the interlocking mechanism 148 ensures precise alignment and coupling of the first and second top portions 120, 124 in forming the top housing 104. Once further secured together via a locking mechanism 184, the first and second top portions 120, 124 are locked together (FIG. 4), as discussed in more detail below.

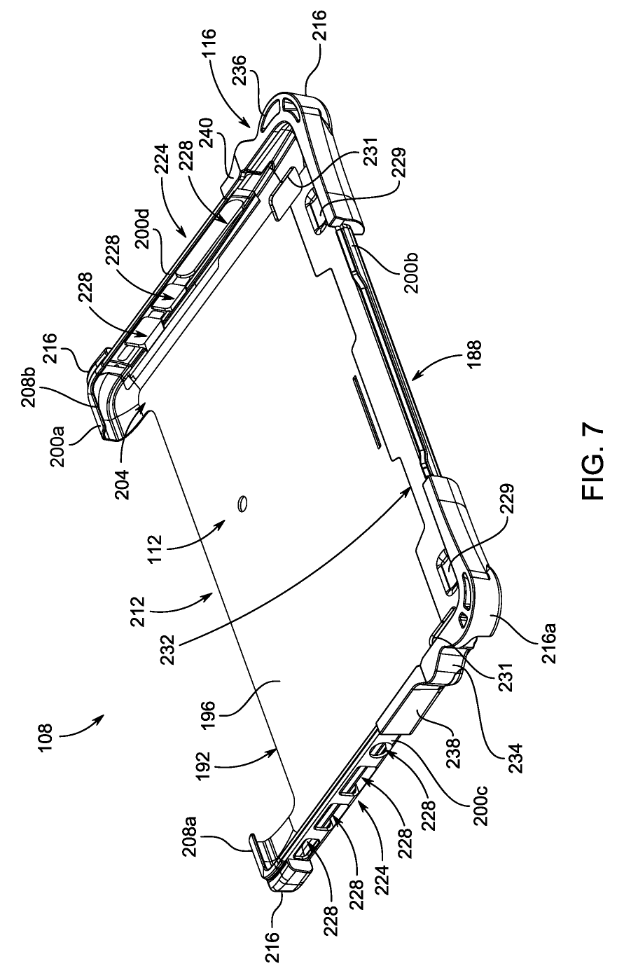

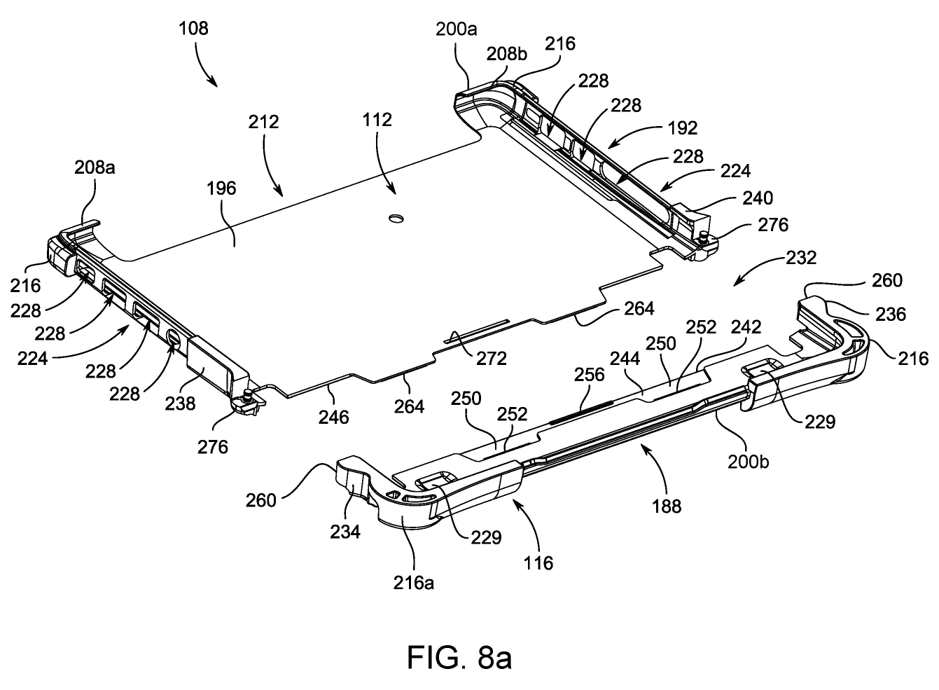

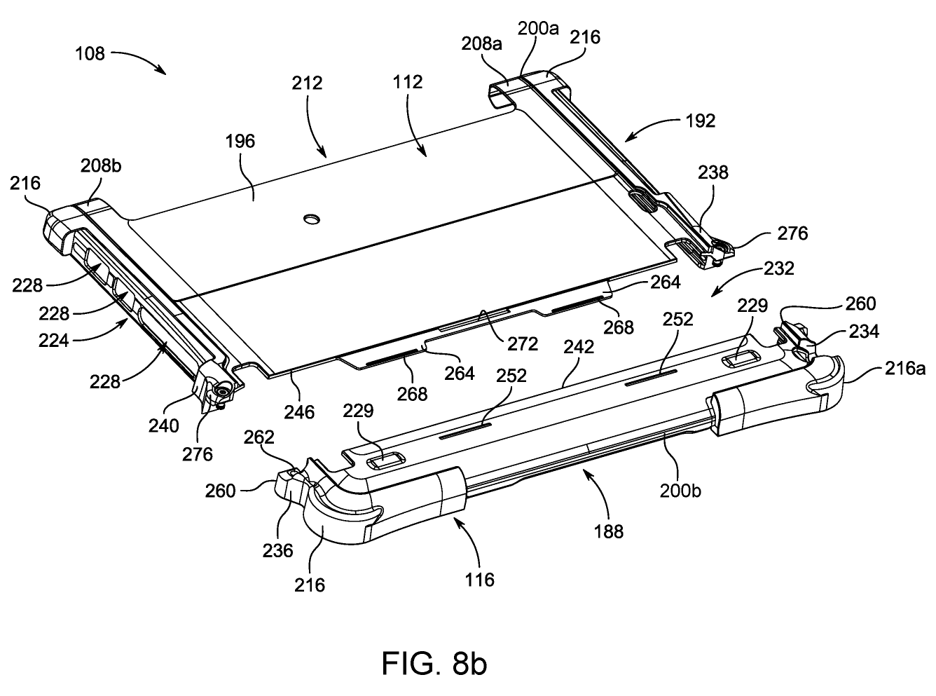

As shown in FIGS. 7-8b, the bottom housing 108 is similar in construction to the top housing 104 and includes a first bottom portion 188 and a second bottom portion 192 configured to be removably coupled to the first bottom portion 188. When coupled together, the first and second bottom portions 188, 192 define a back wall or floor 196 and four rigid sidewalls 200a-d, which may be co-molded with the back wall 196 from the same rigid material as that of the main body 112. In other embodiments, the sidewalls 200a-d may be formed separately from the back wall 196 and subsequently coupled to the back wall 196. The sidewalls 200a-d and the back wall 196 collectively define a cavity 204 to receive and hold the laptop keyboard 18. The rigid sidewalls 200a-d include a bottom sidewall 200a, a top sidewall 200b, a left sidewall 200c, and a right sidewall 200d. When the bottom housing 108 is secured to the laptop 10, the sidewalls 200a-d extend around and capture the periphery of the laptop keyboard 18. As discussed above, like the top housing 104, a resilient rim 116 is coupled to portions of the top sidewall 200b, the left sidewall 200c, and the right sidewall 200d, and provides the bottom housing 108 with rounded corners 216. The rounded corners 216 are shaped and sized to engage an upper surface 18b of the laptop keyboard 18. Together, the sidewalls 200a-d and the rim 116 capture the laptop keyboard 18 to securely hold the laptop keyboard 18 within the bottom housing 108.

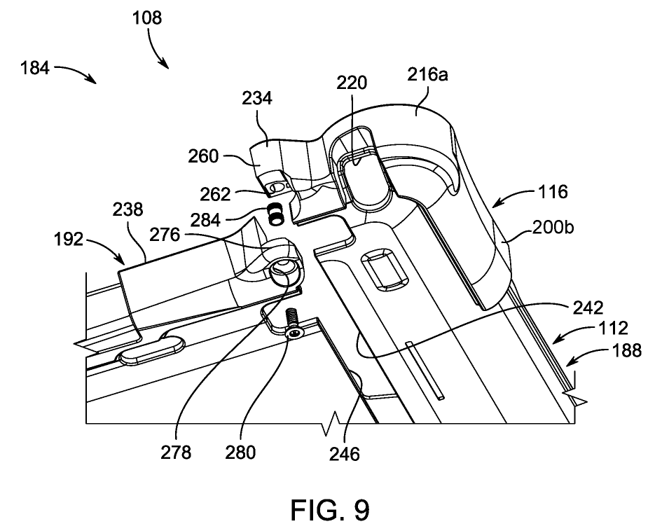

With reference to FIG. 9, one of the corners 216a, which is located at the intersection of the left sidewall 200c and the top sidewall 200b, includes an aperture 220 that aligns with a corresponding bore in the laptop 10 that is configured to hold a digital pen or stylus.

With reference to FIGS. 7-8b, the bottom sidewall 200a includes a first lip 208a positioned adjacent the left sidewall 200c, a second lip 208b positioned adjacent the right sidewall 200d, and an opening 212 extending between the first and second lips 208a, 208b. The lips 208a, 208b are shaped and sized to engage the upper surface 18b of the laptop keyboard 18, securing the bottom housing 108 to the laptop keyboard 18. The opening 212 accommodates the hinges 22 (FIGS. 1-2) of the laptop 10.

With reference to FIGS. 7-8b, the rim 116 partially covers the left and right sidewalls 200c, 200d but does not fully enclose them, creating discontinuities 224. The discontinuities 224 expose segments of the underlying left and right sidewalls 200c, 200d that include a series of openings 228 aligned with ports (FIGS. 1-3) of the laptop 10. For example, the left sidewall 200c includes four openings 228 aligned with a charging port 26, two USB ports 30, and a headphone jack 34, and the right sidewall 200d includes three openings 228 aligned with an HDMI port 38, another USB port 30, and an SD card slot 46. However, the sidewalls 200c, 200d may have fewer or additional openings to accommodate different port configurations.

With reference to FIG. 7, the back wall 196 of the bottom housing 108 may also accommodate components on the underside 18a of the laptop keyboard 18. For example, the wall 196 includes two indentations 229 configured to receive rubber feet and two apertures 231 configured to accommodate vents on the underside 18a of the laptop keyboard 18.

As illustrated in FIGS. 8a-8b, the bottom housing 108 includes a second interlocking mechanism 232, similar to the first interlocking mechanism 148 of the top housing 104, for coupling the first bottom portion 188 and the second bottom portion 192 of the bottom housing 108. The first bottom portion 188 includes the top sidewall 200b, an upper portion 234 of the left sidewall 200c, and an upper portion 236 of the right sidewall 200d. The second bottom portion 192 includes the bottom sidewall 200a, a lower portion 238 of the left sidewall 200c, and a lower portion 240 of the right sidewall 200d. A bottom edge 242 of the first bottom portion 188 includes a recess 244, and an upper edge 246 of the second bottom portion 192 includes a pair of keys 264 shaped and sized to securely fit within the recess 244.

In more detail, the first bottom portion 188 of the bottom housing 108 further includes generally rectangular sections 250, apertures 252, a protrusion 256, first flanges 260, and bores 262 similar to the rectangular sections 156, apertures 160, protrusion 164, first flanges 165, and bores 166 of the first top portion 120 of the top housing 104. Further, the second bottom portion 192 of the bottom housing 108 includes the keys 264, protrusions 268, an aperture 272, second flanges 276, and through holes 278 similar to the rectangular keys 172, protrusions 176, aperture 180, second flanges 181, and through holes 182 of the second top portion 124 of the top housing 104. For the sake of brevity, the details of these components are not repeated in detail, but the description of the first interlocking mechanism 148 equally applies to the description of the second interlocking mechanism 232. That is, when the first bottom portion 188 and the second bottom portion 192 are coupled together, each key 264 is seated within a recess 244, each protrusion 268, 256 extends through a corresponding aperture 252, 272, and the first flanges 260 align with the second flanges 276. As discussed above, like the connections with the top housing 104, because the protrusions 268 and 256 extend in opposite directions into their corresponding apertures 252 and 272, respectively, the engagement of the protrusions 268, 256 with their respective apertures 252, 272 serves to prevent the bottom portions 188 and 192 from being easily separated from each other. Therefore, the second interlocking mechanism 232 provides a precise alignment and secure coupling between the first bottom portion 188 and the second bottom portion 192 to form the bottom housing 108. In some embodiments, the first bottom portion 188 may include a bore configured to receive the insert or an aperture, and the second bottom portion 192 may include the other of the bore or the aperture.

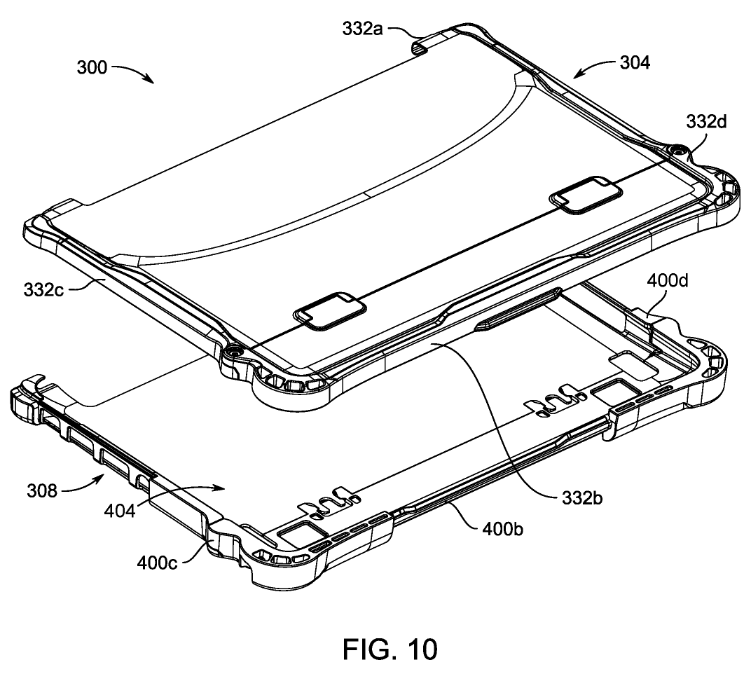

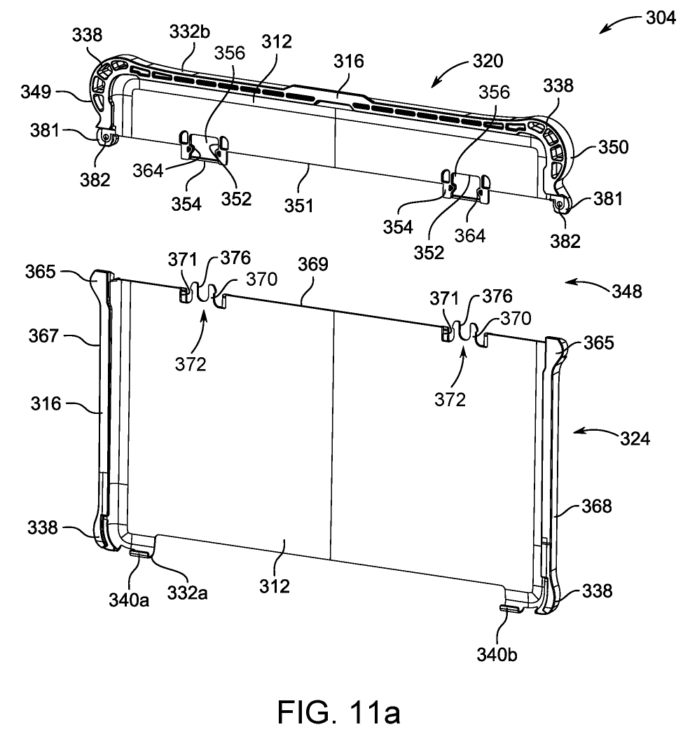

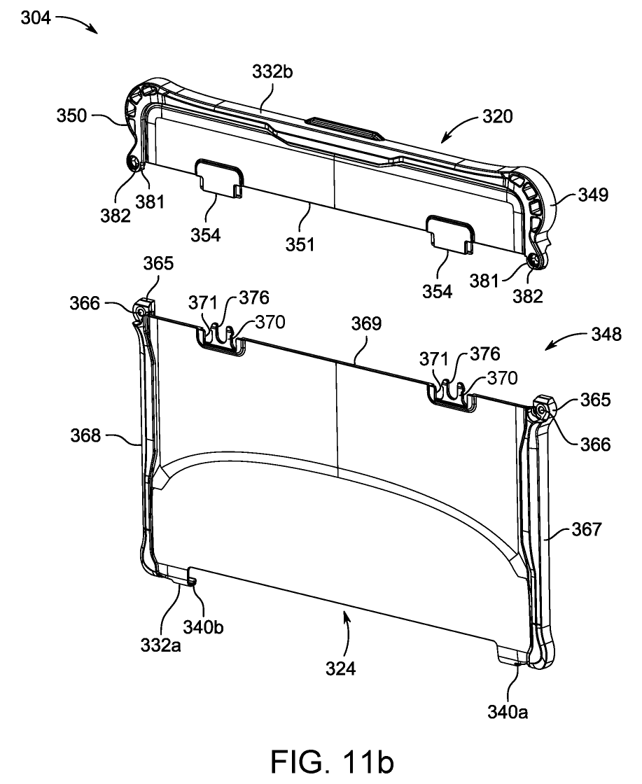

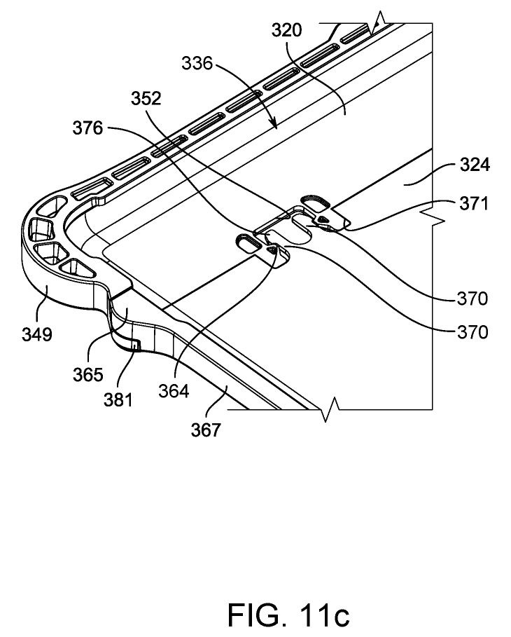

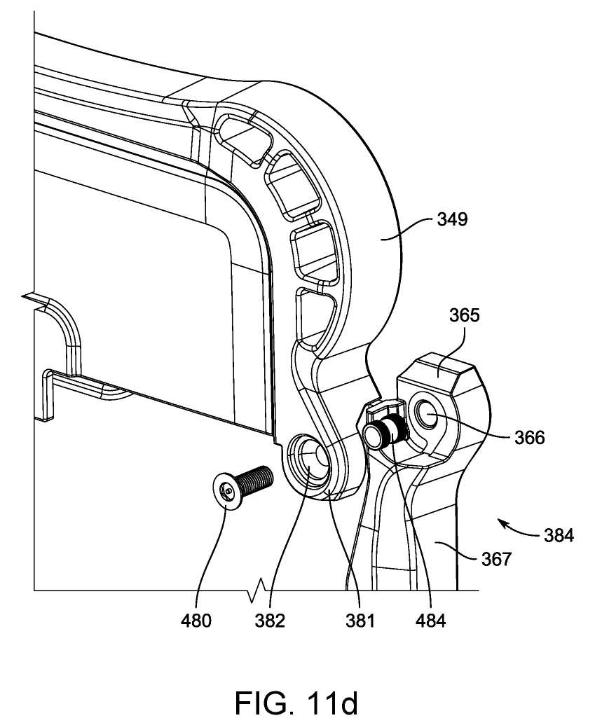

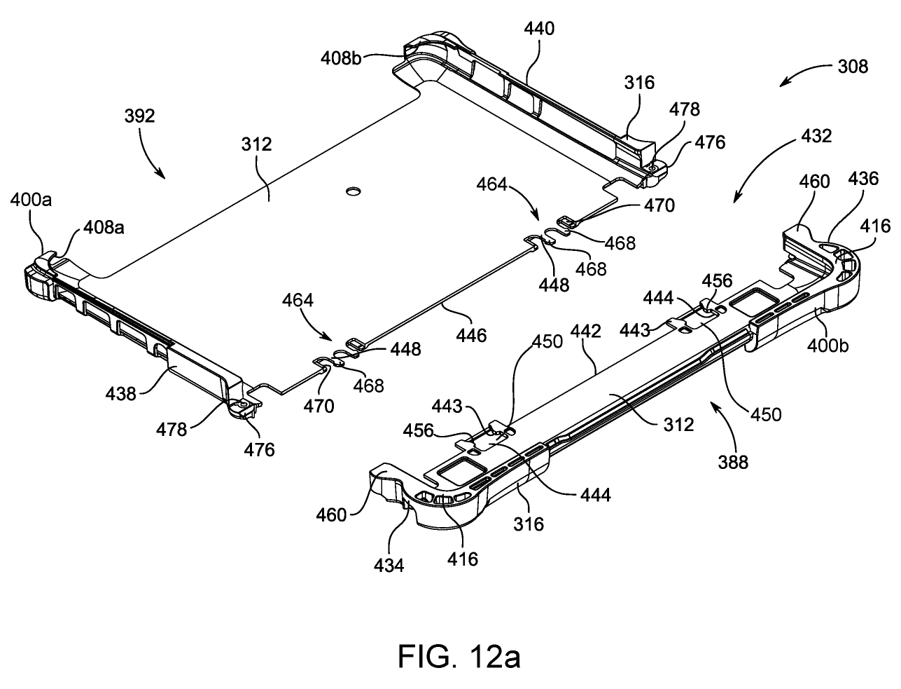

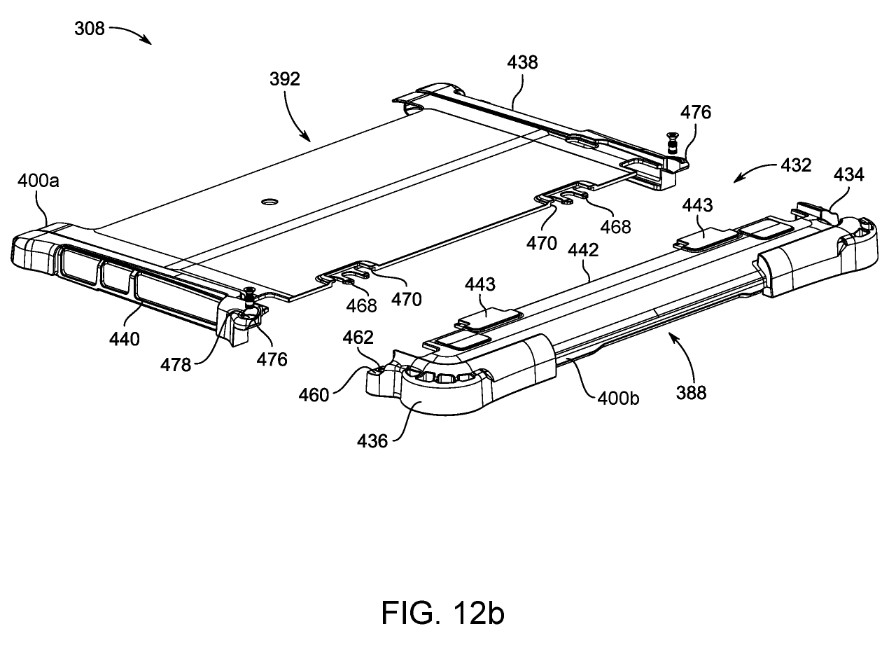

With reference to FIGS. 10-12b, a case 300 having a first interlocking mechanism 348 of a top housing 304 and a second interlocking mechanism 432 of a bottom housing 308 according to an alternative embodiment are illustrated. Specifically, FIG. 10 illustrates a case 300 that is similar to the case of FIGS. 1-9, with differences described below. Further, FIGS. 11a-c illustrate a top housing 304 that is similar to the top housing 104 of FIGS. 4-5b, with the differences described below. Likewise, FIGS. 12a-b illustrate a bottom housing 308 that is similar to the bottom housing 108 of FIGS. 7-8b, with the differences described below. Features and structures of the top housing 304 and bottom housing 308 that are the same or similar to the features and structures of the top housing 104 and bottom housing 108, respectively, are designated by the same reference numeral increased by a value of two hundred.

As illustrated in FIGS. 10-12b, the top housing 304 and bottom housing 308 include a main body 312 and a rim 316. The rim 316 of the top housing 304 provides the top housing 304 with rounded corners 338. The rounded corners 338 are sized and shaped to engage a front surface 14b of a laptop display screen 14. The rim 316 of the bottom housing 308 provides the bottom housing 308 with rounded corners 416. The rounded corners 416 are sized and shaped to engage an upper surface 18b of a laptop keyboard 18.

With reference to FIGS. 11a-c, the top housing 304 includes a first top portion 320 and a second top portion 324 configured to be removably coupled to the first top portion 320. The first top portion 320 and the second top portion 324 are coupled via the interlocking mechanism 348. The first and second top portions 320 collectively define a cavity 336 (FIG. 11c) to receive and hold the laptop display screen 14. With reference to FIG. 11a (a front perspective view of the top housing), the first top portion 320 includes a top sidewall 332b, an upper corner portion 349 of a left sidewall 332c, and an upper corner portion 350 of a right sidewall 332d.

With continued reference to FIGS. 11a-c, the bottom edge 351 of the first top portion 320 includes two spaced tabs 354 extending in a first direction (toward the second top portion 324 when the first and second top portions 320, 324 are joined). In other embodiments, the bottom edge 351 may include fewer or more tabs 354. Each of the tabs 354 of the first top portion 320 includes a recess 352 and a pair of mating features configured as opposed protruding catches 364, or as protrusions 364. In the illustrated embodiment, the protrusions 364 each project into the recess 352. The recesses 352 each define a rectangular section 356. In other embodiments, the recesses 352 and the protrusions 364 may have different shapes.

With reference to FIGS. 11a-b, the second top portion 324 of the top housing 304 includes a bottom sidewall 332a, a lower portion 367 of the left sidewall 332c, and a lower portion 368 of the right sidewall 332d. The top housing 304 includes lips 340a, 340b on the bottom sidewall 332a that are sized and shaped to engage the front surface 14b of the laptop display screen 14. An upper edge 369 of the second top portion 324 includes a pair of recesses 371, each sized and shaped to receive one of the tabs 354 of the first top portion 320, with each recess 352 of the first top portion 320 receiving a key 372. Each key 372 includes a pair of mating features configured as resilient projections 370 positioned in each recess 371. The projections 370 are sized and shaped to fit securely in the recesses 352. The projections 370 each extend in a second direction toward the first top portion 320 (when the first and second top portions 320, 324 are joined) opposite the first direction. Each projection 370 has a distal protrusion 376 cantilevered therefrom (FIG. 11c). Each protrusion 372 of the second top portion 324 extends toward a respective one of the protrusions 364 of the of the first top portion 320.

With reference to FIG. 11b (a rear perspective view of the top housing), on the second top portion 324, distal ends of the lower portions 367, 368 of the left sidewall 332c and right sidewall 332d are recessed or offset in a first recess direction, thereby forming two first flanges 365, each of which includes a bore 366. On the first top portion 320, distal ends of the upper portion 349 of the left sidewall 332c and the upper portion 350 of the right sidewall 332d are recessed or offset in a second recess direction opposite the first recess direction, thereby forming two second flanges 381, each corresponding to a first flange 365 and including a through hole 382. When the first and second top portions 320, 324 of the top housing 304 are aligned and joined, each of the first flanges 365 will align with a corresponding second flange 381 to align each through hole 382 with a corresponding bore 366.

With reference to FIG. 11c (an enlarged front perspective view of the top housing), during coupling, when the first top portion 320 and the second top portion 324 are brought together to engage one another, the keys 372 are seated within the recesses 352. Specifically, the keys 372 fit into and are seated in the rectangular sections 356 defined by the recesses 352. As such, the projections 370 are received and seated in the recesses 352 of the tabs 354. When the projections 370 are seated within the recesses 352, each resilient projection 370 deflects and is biased inward as each respective protrusion 376 contacts and slides along one of the respective protrusions 364 of the first top portion 320. As the projections 370 continue to advance into the recesses 352 of the first top portion 320 and deflect inward, they pass over and clear the protrusions 364 of the first top portion 320. Once the protrusions 376 of the second top portion 324 move past and clear the protrusions 364 of the first top portion 320, the projections 370 spring back outward to their original orientation, positioning and securing the protrusions 376 of the second top portion 324 within the space formed behind the protrusions 364 of the first top portion 320. As such, each protrusion 376 of the second top portion 324 is seated (e.g., secured) within the space behind one of the protrusions 364 of the first top portion 320 to prevent the first top portion 320 and the second top portion 324 from easily being separated from each other. Because the protrusions 364, 376 extend in opposite directions into engagement with each other, the engagement of the protrusions 364, 376 serves to prevent the top portions 320 and 324 from being easily separated from each other. Thus, the first interlocking mechanism 348 provides a precise alignment and secure coupling between the first top portion 320 and the second top portion 324. Once further secured together via a locking mechanism 384, the first and second top portions 320, 324 are locked together (FIG. 11d), as discussed in more detail below.

As shown in FIGS. 12a-b, the bottom housing 308 is similar in construction to the top housing 304 and includes a first bottom portion 388 and a second bottom portion 392 configured to be removably coupled from the first bottom portion 388. The bottom housing 308 includes the second interlocking mechanism 432 similar to the first interlocking mechanism 348 of the top housing 304, for coupling the first bottom portion 388 and the second bottom portion 392 of the bottom housing 308. When coupled together, the first and second bottom portions 388 collectively define a cavity 404 (FIG. 10) to receive and hold the laptop keyboard 18. With reference to FIG. 12a (a front perspective view of the bottom housing), the first bottom portion 388 includes a top sidewall 400b, an upper corner portion 434 of a left sidewall 400c, and an upper corner portion 436 of a right sidewall 400d. The second bottom portion 392 includes a bottom sidewall 400a, a lower portion 438 of the left sidewall 400c, and a lower portion 440 of the right sidewall 400d. The bottom housing 308 includes lips 408a, 408b on the bottom sidewall 400a that are sized and shaped to engage the upper surface 18b of the laptop keyboard 18. A bottom edge 442 of the first bottom portion 388 includes recesses 444, and an upper edge 446 of the second bottom portion 392 includes a pair of keys 464. Each key 464 includes a pair of mating features configured as projections 448 sized and shaped to fit securely in the recesses 444 of the first bottom portion 388.

In more detail, the first bottom portion 388 includes generally rectangular sections 450, tabs 443, and protrusions 452, similar to the generally rectangular sections 356, tabs 354, and protrusions 364 of the first top portion 320 of the top housing 304. Distal ends of the upper portions 434, 436 of the left sidewall 400c and right sidewall 400d are offset and recessed, thereby forming two first flanges 460, each of which includes a bore 462. Further, the second bottom portion 392 includes recesses 470 and protrusions 468, similar to the recesses 371 and protrusions 376 of the second top portion 324. Distal ends of the lower portions 438, 440 of the left and right sidewalls 400c, 400d are offset and recessed, thereby forming two second flanges 476, each corresponding to a first flange 460 and including a through hole 478. In some embodiments, the first bottom portion 388 may have through holes, and the second bottom portion 392 may have bores.

For the sake of brevity, the details of structure and operation of components on the bottom housing 308 that correspond to like components on the top housing 304 are not repeated in detail. The description of the first interlocking mechanism 348 equally applies to the description of the second interlocking mechanism 432. That is, when the first bottom portion 388 and the second bottom portion 392 are coupled together, each key 464 is seated within a recess 444, each protrusion 468 of the second bottom portion 392 is seated within the space behind the protrusion 452 of the first bottom portion 388, and the first flanges 460 align with the second flanges 476. As discussed above in connection with the top housing 304, because the protrusions 452, 468 extend in opposite directions into engagement with each other, the engagement of the protrusions 452, 468 serves to prevent the bottom portions 388, 392 from being easily separated from each other. Thus, the second interlocking mechanism 432 provides a precise alignment and secure coupling between the first bottom portion 388 and the second bottom portion 392 to form the bottom housing 308. Once further secured together via a locking mechanism similar to the locking mechanism 184, the first and second bottom portions 388, 392 are locked together, as discussed in more detail below.

With reference to FIG. 6 (an enlarged front perspective view of a top housing), FIG. 9 (an enlarged rear perspective view of a bottom housing) and FIG. 11d (an enlarged front perspective view of another top housing), as mentioned above, the case 100 includes a locking mechanism 184, 384 for securing the case 100 to a laptop 10, such that the case 100 cannot be easily or accidentally removed. As described below, the locking mechanism 184 securely fastens together the first top portion 120, 320 to the second top portion 124, 324 of the top housing 104, 304 to inhibit removal of a laptop screen 14 held within the top housing 104, 304 (FIG. 6). A separate identical locking mechanism 184 is also used to securely fasten the first bottom portion 188, 388 to the second bottom portion 192, 392 of the bottom housing 108, 308 (FIG. 9) to inhibit removal of a laptop keyboard 18 held within the bottom housing 108, 308.

The locking mechanism 184, 384 includes at least one fastener 280, 480 and one insert 284, 484. In the illustrated embodiments, the locking mechanism 184, 384 includes four fasteners 280, 480 and four inserts 284, 484. In a preferred embodiment, the fasteners 280, 480 are tamper-resistant hex screws, while the inserts 284 are threaded bushings with both inner and outer threads. Each insert 284, 484 is shaped and sized to be received within any one of the bores 166, 162, 366, 462 and includes a textured or roughened outer surface to provide a secure friction fit with the inner surface of the receiving bore 166, 162, 366, 462. The inner surface of each insert 284, 484 is threaded to receive a hex screw 280, 480. Alternative configurations may use different types of fasteners and inserts, depending on the specific application.

In some embodiments, to secure the case 100 to the laptop 10, the user first places each of the inserts 284, 484 into one of the bores 166, 262, 462 of the first portions 120, 188, 388 of the top housing 104, 304 and/or the bottom housing 108, 308. In some embodiments, to secure the case 100 to the laptop 10, the user first places each of the inserts 484 into one of the bores 366 of the second top portion 324 of the top housing 304. In some embodiments, to secure the case 100 to the laptop 10, the user first places each of the inserts 484 into bores of a second bottom portion of a bottom housing.

The user may choose to use only the top housing 104, 304, only the bottom housing 108, 308, or both housings 104, 108, 304, 308 together, depending on their preferences or the needs of any particular application. Specifically, the user may choose to use the top housing 104, 304 without a bottom housing 108, 308 or with a bottom housing formed as one piece. Likewise, the user may choose to use the bottom housing 108, 308 without the top housing 104, 304 or in combination with a top housing formed as one piece.

If the top housing 104, 304 is used, each top portion 120, 124, 320, 324 is coupled to the display screen 14 with the display screen’s rear surface 14a facing and supported by the back wall 128, as illustrated in FIGS. 1-2. For example, the second top portion 124, 324 can first be slidingly placed around a portion of the laptop display screen 14 and the first top portion 120, 320 can then be slidingly placed around the remaining portion of the display screen 14. When brought together, the first and second top portions 120, 124, 320, 324 can be coupled together via the interlocking mechanism 148, 348. Of course, the top housing 104, 304 can be placed around the display screen 14 in a different assembly sequence in which the first top portion 120, 320 is first placed around a portion of the display screen 14 and the second top portion 124, 324 is next placed around the remaining portion of the display screen. In either sequence, the top housing portions 120, 124, 320, 324 are coupled together via the interlocking mechanism 148, 348 such that the lips of the rounded corners 138, 338 of the first top portion 120, 320 and the lips 140a, 140b, 340a, 340b of the second top portion 124, 324 engage the front surface 14b of the display screen 14.

Similarly, if the bottom housing 108, 308 is used, each bottom housing portion 188, 192, 388, 392 is coupled to the underside 18a of the keyboard portion 18. The bottom housing portions 188, 192, 388, 392 are coupled together in a manner similar to the assembly of the top housing 104, 304 around the display screen 14 as described above, with the lips of the rounded corners 216, 416 of the first bottom portion 188, 388 and the lips 208a, 208b, 408a, 408b of the second bottom portion 192, 392 engaging the upper surface 18b of the keyboard portion 18.

Once the laptop 10 is placed in the top housing 104, 304 and/or the bottom housing 108, 308, as discussed above, the interlocking mechanisms 148, 232, 348, 432 are engaged, thereby serving to prevent movement of the first housing portions 120, 188, 320, 388 away from the second housing portions 124, 192, 324, 392. Additionally, the first flanges 165, 260, 460 align with the second flanges 181, 276, 476 such that the bores 166, 262, 462 of the first flanges 165, 260, 460 align with the through holes 182, 278, 478 of the second flanges 181, 276, 476.

Finally, the user threads each fastener 280, 480 into one of the holes 182, 278, 382, 478 of the second flanges 181, 276, 381, 476 and into the aligned bores 166, 262, 366, 462 of the first flanges 165, 260, 365, 460. In some embodiments, the fasteners 280, 480 are inserted from an exterior of the case 100 (see FIGS. 9 and 11d). In some embodiments, the fasteners 280 are inserted on a front side of the screen 14 (see FIG. 6). The fasteners 280, 480 are threaded into the inserts 284, 484 until securely fastened. When the first and second portions of the top and bottom housings 104, 108, 304, 308 are fastened in an assembled state as described, the interlocking mechanisms 148, 232, 348, 432 and the separate locking mechanisms 184, 384 (one locking mechanism 184, 384 for each of the top housing 104, 304 and the bottom housing 108, 308) cooperate to provide an improved independent locking system for each housing 104, 108, 304, 308 that inhibits the inadvertent or unauthorized removal of the housings from the laptop screen 14 and keyboard portion 18, respectively.

The case 100, 300 thus offers several key advantages that enhance its utility and security for users. The cooperation of the interlocking mechanism 148, 232, 348, 432 with the locking mechanism 184, 384 is designed to inhibit unauthorized removal of the case 100, 300, making it particularly beneficial in environments such as schools or workplaces where devices are frequently shared or used by students or employees. The use of tamper-resistant hex screws ensures that the case 100, 300 cannot be easily disassembled without the proper tools, providing an added layer of security against accidental or intentional removal. Additionally, the locking mechanism 184, 384 is composed of very few parts, which simplifies the assembly process and reduces the risk of component loss during installation or maintenance. Furthermore, the modular nature of the case 100, 300 allows the top housing 104, 304 and the bottom housing 108, 308 to be used together or independently, depending on the user’s specific needs. This versatility ensures that the user can protect the display screen 14, the keyboard portion 18, or both, offering flexibility for a variety of applications while maintaining full operability of the device.

In some embodiments, the case 100, 300 may have a housing that may be represented by only one of the housings 104, 304, 108, 308. Specifically, the housing may include what is described above as the top housing 104, 304 such that the first top portion 120, 320 is the first housing portion and the second top portion 320, 324 is the second housing portion. Alternatively, the housing may include what is described above as the bottom housing 108, 308 such that the first bottom portion 188, 388 is the first housing portion, and the second bottom portion 192, 392 is the second housing portion.

Although the invention has been described in detail with reference to certain preferred embodiments, variations and modifications exist within the scope and spirit of one or more independent aspects of the invention as described.

What is claimed is:

1. A top housing of a case for a display screen of an electronic device, the top housing comprising:
a first top portion having
a protrusion extending in a direction, and
a flange including one of a bore or a through hole defined therein;
a second top portion removably coupled to the first top portion to collectively define a cavity configured to receive the display screen, the second top portion having
a protrusion extending in a direction opposite the direction of extension of the protrusion of the first top portion, and
a flange including another of the bore or the through hole defined therein;
an interlocking mechanism coupling the first top portion to the second top portion, the interlocking mechanism including the protrusion of the first top portion and the protrusion of the second top portion; and
a locking mechanism removably locking the first top portion to the second top portion, the locking mechanism having a fastener extending through the through hole and into the bore.

2. The top housing of claim 1, wherein the locking mechanism has an insert that is positioned within the bore and that receives the fastener.

3. The top housing of claim 1, wherein the second top portion includes a key having the protrusion of the second top portion, and the first top portion includes a recess receiving the key, and wherein the interlocking mechanism includes the key and the recess.

4. The top housing of claim 3, wherein the interlocking mechanism includes an aperture that is positioned in the recess of the first top portion and that receives the protrusion of the second top portion.

5. The top housing of claim 3, wherein the protrusion of the first top portion projects into the recess of the first top portion and engages the protrusion of the second top portion therein.

6. The top housing of claim 1, wherein the first top portion and the second top portion collectively define a back wall configured to engage a first surface of the display screen of the electronic device, and a plurality of sidewalls configured to extend around a periphery of the display screen of the electronic device.

7. The top housing of claim 6, wherein one of the plurality of sidewalls includes a lip configured to engage a second surface of the display screen of the electronic device, the second surface being opposite the first surface.

8. A case for an electronic device having a keyboard and a display screen, the case comprising the top housing of claim 1, and a bottom housing including:
a first bottom portion having
a protrusion extending in a direction, and
a flange including one of a bore or a through hole defined therein;
a second bottom portion removably coupled to the first bottom portion to collectively define a cavity configured to receive the keyboard, the second bottom portion having
a protrusion extending in a direction opposite the direction of extension of the protrusion of the first bottom portion, and
a flange including another of the bore or the through hole defined therein;
an interlocking mechanism coupling the first bottom portion to the second bottom portion, the interlocking mechanism of the bottom housing including the protrusion of the first bottom portion and the protrusion of the second bottom portion; and
a locking mechanism removably locking the first bottom portion to the second bottom portion, the locking mechanism of the bottom housing having a fastener extending through the through hole and into the bore.

9. A bottom housing of a case for a keyboard of an electronic device, the bottom housing comprising:
a first bottom portion having
a protrusion extending in a direction, and
a flange including one of a bore or a through hole defined therein;
a second bottom portion removably coupled to the first bottom portion to collectively define a cavity configured to receive the keyboard, the second bottom portion having
a protrusion extending in a direction opposite the direction of extension of the protrusion of the first bottom portion, and
a flange including another of the bore or the through hole defined therein;
an interlocking mechanism coupling the first bottom portion to the second bottom portion, the interlocking mechanism including the protrusion of the first bottom portion and the protrusion of the second bottom portion; and
a locking mechanism removably locking the first bottom portion to the second bottom portion, the locking mechanism having a fastener extending through the through hole and into the bore.

10. The bottom housing of claim 9, wherein the locking mechanism has an insert that is positioned within the bore and that receives the fastener.

11. The bottom housing of claim 9, wherein the second bottom portion includes a key having the protrusion of the second bottom portion, and the first bottom portion includes a recess receiving the key, and wherein the interlocking mechanism includes the key and the recess.

12. The bottom housing of claim 11, wherein the interlocking mechanism includes an aperture that is positioned in the recess of the first bottom portion and that receives the protrusion of the second bottom portion.

13. The bottom housing of claim 11, wherein the protrusion of the first bottom portion projects into the recess of the first bottom portion and engages the protrusion of the second bottom portion therein.

14. The bottom housing of claim 9, wherein the first bottom portion and the second bottom portion collectively define a back wall configured to engage a first surface of the keyboard of the electronic device, and a plurality of sidewalls configured to extend around a periphery of the keyboard of the electronic device.

15. The bottom housing of claim 14, wherein one of the plurality of sidewalls includes a lip configured to engage a second surface of the keyboard of the electronic device, the second surface being opposite the first surface.

16. The bottom housing of claim 14, wherein the plurality of sidewalls include a plurality of openings aligned with ports of the electronic device.

17. A case for an electronic device, the case comprising:
a first housing portion including a first flange having at least one of a bore and a through hole;
a second housing portion configured to be coupled to the first housing portion and including a second flange having the other of the bore and the through hole;
an insert configured to be positioned within the bore; and
a fastener configured to extend through the through hole and into the insert after the first housing portion and the second housing portion are coupled,
wherein the fastener extends into the insert to inhibit removal of the electronic device from the case.

18. The case of claim 17, wherein the fastener is a tamper-resistant hex screw.

19. The case of claim 17, wherein the insert includes a threaded inner surface configured to engage a threaded outer surface of the fastener and/or a textured outer surface configured to provide a frictional fit between the insert and the bore.

20. The case of claim 17, further comprising an interlocking mechanism configured to align and couple the first housing portion to the second housing portion.
